(19) United States
(12) Patent Application Publication
(10) Pub. No.: US 2007/0194580 A1
(43) Pub. Date: Aug. 23, 2007

(54) Pet waste retriever with removable container

(76) Inventor: Jason Raasch, Lake Barrington, IL (US)

Correspondence Address: Lawrence J. Crain;GREER, BURNS & CRAIN. LTD., Suite 2500, 300 South Wacker Drive, Chicago, IL, 60606, US

(21) Appl. No.: 11/358,179

(22) Filed: Feb. 21, 2006

(51) Int. Cl. A01K 29/00

(52) U.S. Cl. 294/1.4

(57) ABSTRACT

A pet waste retriever for use with a disposable container includes an outer frame defining a central passageway and having a handle end, and an opposite container end defining an opening in communication with the passageway. An inner frame is dimensioned for sliding engagement in the passageway and has a grip end associated with the handle end and a jaw end associated with the container end, the jaw end provided with at least one jaw. The inner frame is assembled into the outer frame without the use of tools.

### BACKGROUND

The present invention relates generally to devices for retrieving pet waste, particularly from dogs, and more specifically to a device which eliminates the use of handheld bags for retrieving the waste from the ground.

Pet refuse left on lawns, sidewalks or streets causes sanitary problems, particularly in large urban areas. Many cities have enacted local ordinances requiring that the pet owner clean up after their pets. This task is not only unpleasant to perform, but is often awkward to accomplish at the same time as holding a dog by a leash. Many pet owners carry at least one plastic bag for picking up pet waste. The bag is employed like a crude glove, and is used to cover, surround, and then retrieve the waste from the ground. Waste-filled bags are then disposed of. While the use of such bags is an accepted practice, there is a need for a more sanitary and less demeaning system for pet waste retrieval.

From U.S. Pat. No. 5,601,321 it is known to provide a handheld waste retriever employing an outer frame with a spring-biased inner frame. A pair of pivoting scoop members is manipulated by manual grasping of the inner frame relative to the outer frame against the spring biasing force. The scoop members are biased in a closed position and the user squeezes on the handle to open the scoop members and thus envelop the waste. The scoop members come into direct contact with the waste and are thus soiled, making subsequent handling and storage of the device problematical.

U.S. Pat. No. 4,247,139 discloses a waste collector using a similar biased grasping principle, but featuring a disposable container attachable to gripping structure under the control of a handle. The container has adhesive along its edges for securing the waste. A separate ejector rod is manipulated by the user to eject the filled container. One drawback of this apparatus is its relative complexity, and the requirement of assembly using rivet-like fasteners to retain the handle halves together.

U.S. Pat. No. 4,477,111 discloses a pet waste pickup device employing a tubular, multi-component telescoping handle used to manipulate a pair of spring-loaded jaws. A specially-designed disposable bag with an upper eyelet is manually loaded onto the jaws, sealed with tape after enclosing the waste and ejected from the handle upon retraction of an axial plunger. Besides requiring specialized bags, requiring assembly, the handle is relatively complicated to manufacture.

Therefore, there is a need to provide an improved device, preferably requiring only single-handed operation, for cleaning up after a pet in a sanitary fashion. There is also a need for an improved pet waste retriever using a disposable container which is strongly constructed, yet is inexpensive to manufacture.

### BRIEF SUMMARY OF THE INVENTION

The above-listed objects are met or exceeded by the present pet waste retriever with removable container or cartridge, which features one-handed pet waste retrieving action, collection and storage of the waste without owner contact, and easy ejection of the waste container into a refuse collection receptacle. Since, during normal operation, the retriever never touches the waste, it is easily carried and/or stored by the user when not in use. Further, the present waste retriever is simpler to assemble and operate than prior art devices.

More specifically, a pet waste retriever for use with a disposable container includes an outer frame defining a central passageway and having a handle end, and an opposite container end defining an opening in communication with the passageway. An inner frame is dimensioned for sliding engagement in the passageway and has a grip end associated with the handle end and a jaw end associated with the container end, the jaw end provided with at least one jaw. The inner frame is assembled into the outer frame without the use of tools.

In another embodiment, a pet waste retriever for use with a disposable container includes an elongate outer frame defining a central passageway and having a handle end, and an opposite container end defining an opening in communication with the passageway. An elongate inner frame is dimensioned for sliding engagement in the passageway, has a grip end associated with the handle end and a jaw end associated with the container end. The jaw end is provided with a pair of laterally biased jaws configured for engaging the disposable container.

In still another embodiment, a disposable clamshell container is configured for use with a pet waste retriever with an outer frame defining a central passageway and a handle end, and an opposite container end defining an opening in communication with the passageway, an elongate inner frame dimensioned for sliding engagement in the passageway and having a grip end associated with the handle end and a jaw end associated with the container end, the container end provided with a pair of jaws. The container includes first and second clamshell halves hingedly joined along a common side edge, the clamshell halves defining a storage space for pet waste, opposing portions of the clamshell halves being attachable to each other for holding the clamshell halves together. At least one grappling point is associated with said common edge and constructed and arranged so that a pulling force acting on the grappling point will cause the clamshell halves to close.

### BRIEF DESCRIPTION OF THE SEVERAL VIEWS OF THE DRAWINGS

FIG. 1 is a top perspective view of the present pet waste retriever with a clamshell container in the open position;

FIG. 2 is an exploded perspective view of the device of FIG. 1, the clamshell container being omitted;

FIG. 3 is a fragmentary bottom perspective view of the device of FIG. 1;

FIG. 4 is a side elevation of the device shown in FIG. 3;

FIG. 5 is a side elevation of the device of FIG. 3, shown in the retracted or container closed position;

FIG. 6 is a top perspective view of the device of FIG. 1 shown positioned over pet waste;

FIG. 7 is a top perspective view of the device of FIG. 1 shown with the clamshell container enclosing the target pet waste;

FIG. 8 is a top perspective view of the device of FIG. 1 shown with the user preparing to eject the filled clamshell container;

FIG. 9 is a top perspective view of the device of FIG. 1 shown ejecting the waste container; and

FIG. 10 is a top perspective view of an alternate embodiment of the waste retriever of FIG. 1.

### DETAILED DESCRIPTION OF THE INVENTION

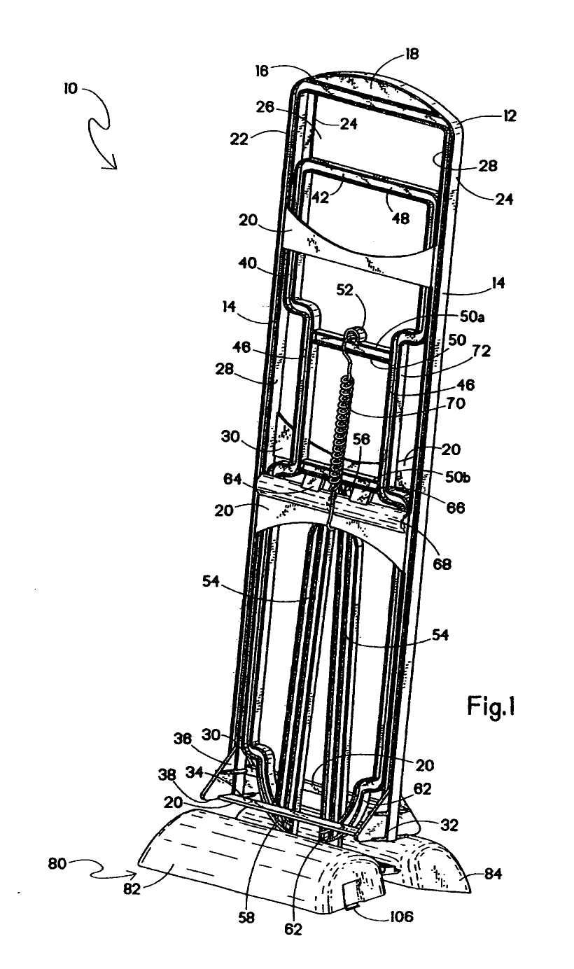

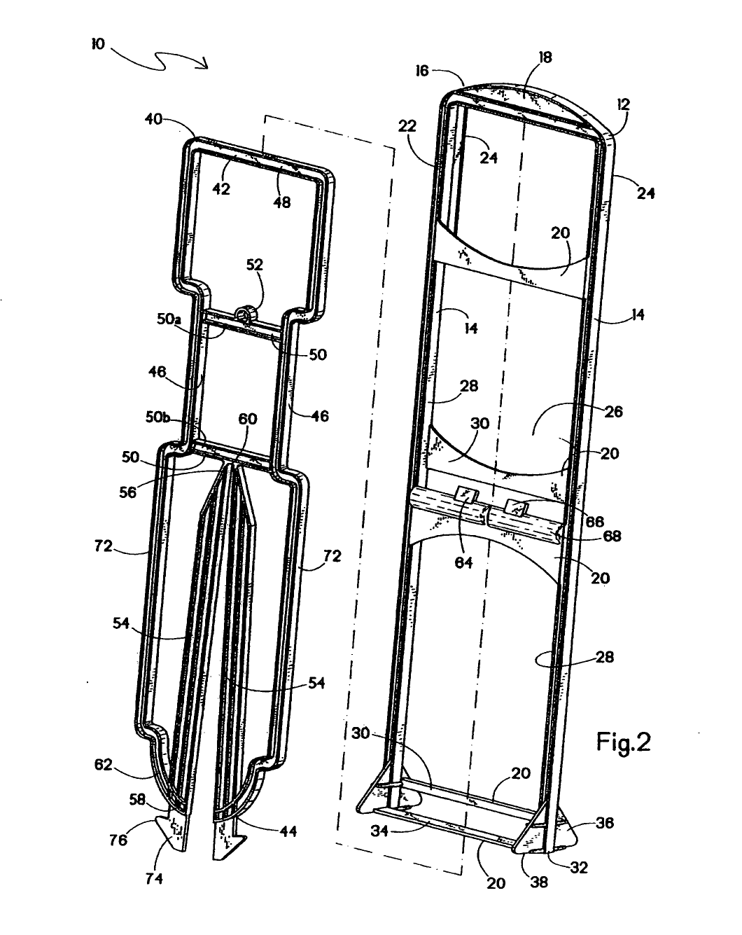

Referring now to FIGS. 1 and 2, a pet waste retriever for use with a disposable container is generally designated 10 and is intended for use in retrieving pet droppings without owner contact with the droppings, or even with the waste-filled container. The retriever 10 is preferably made of injection molded plastic, however other materials such as metals or wood are contemplated, as well as other fabrication techniques known to skilled practitioners. An important feature of the present retriever 10 is that it is assembled without the use of tools, and upon full assembly only has three main components.

First, an elongate outer frame 12 is preferably generally flattened and forms a generally rectangular shape, however other shapes are considered suitable. The outer frame 12 is made of a pair of spaced, parallel main rails 14 joined at a handle end 16 by a handle 18. A plurality of support panels or ribs 20 located on opposite edges 22, 24 of the main rails 14 define a central passageway 26 bordered by inner edges 28 of the main rails and inner walls 30 of the panels 20. Opposite the handle end 16 is a container end 32 defining an opening 34 in communication with the passageway 26.

Also found at the container end 32 is at least one and preferably two dual sided, preferably wedge-shaped cam surfaces 36 projecting generally normally from the main rails 14 and being inclined toward the handle end 16. Cam lobes 38 are formed by a lower surface of the cam surface 36 and are preferably radiused. The cam surfaces 36, as well as the cam lobes 38 are contemplated as being shaped as a cam, ramp, bead or other contact surface actuating a closing of a clamshell-type container as described below. Note that the surfaces 38 need not be horizontal, and in some applications are inclined slightly from the rail 14. Also, reinforcement ribs 39 are contemplated as desired for supporting the cam lobes 38. As desired, the panels 20 may be expanded linearly from the handle end 16 to the container end 32 for ornamental purposes, or for adding strength to the outer frame 12.

An elongate inner frame 40 is also generally flattened and is dimensioned for sliding engagement in the passageway 26. The inner frame 40 has a grip end 42 associated with the handle end 16, and a jaw end 44 associated with the container end 32. As is the case with the outer frame 12, the inner frame 40 is made up of a pair of generally parallel, spaced frame members 46 joined at the grip end 42 by a grip bar 48. Each of the outer frame 12 and the inner frame 40 are preferably unitarily constructed by injection molding or other suitable techniques. However, fabrication from distinct parts is also contemplated.

At least one and preferably two support bars 50 connect the frame members 46 together. A first support bar 50a is provided with at least one eyelet 52, and a second support bar 50b supports the attachment of at least one and preferably a pair of tong-like jaws 54, each having a pivot end 56 and an opposite free end 58. At the pivot end 56, the jaws 54 are connected together by a generally arcuate hinge strip 60 (FIG. 2) which is generally centrally located on the second support bar 50b. The construction and arrangement of the hinge strip 60 is variable as long as the jaws 54 are biased laterally outwardly toward the frame members 46. In the preferred embodiment, the jaws 54 are generally straight, and their free ends 58 are biased outwardly. However, it is also contemplated that the jaws 54 are not biased, but held in place, being movable through action of the configuration of the free ends 58 against a container, as described below.

Opposite the hinge strip 60, the free ends 58 project towards the opening 34 and are connected to ends 62 of the frame members 46, which are preferably arcuate for strength and stability, however other shapes are considered suitable. The connection of the free ends 58 to the ends 62 also enhances the biasing force urging the jaws 54 laterally outwardly.

An advantage of the present retriever 10 over the prior art devices is that it is assembled without the use of tools. Basically, assembly consists of inserting the inner frame 40, grip end 42 first, into the opening 34. The inner frame 40 is axially slid into the passageway 26. Preferably the insertion is not complete, allowing for a biasing member 70, such as a coiled spring, a rubber band or other similar biasing member to be connected between the outer frame 12 and the inner frame 40 to exert a biasing force urging the jaws 54 through the opening 34. In the preferred embodiment, the spring 70 is connected to the support panel 68 and to a mounting point such as the eyelet 52, however other mounting points are contemplated as long as the desired biasing force is obtained.

As the insertion progresses, the second support bar 50b passes a latch 64 on the outer frame 12, the latch preferably including at least one and preferably two inclined or ramped barb members 66 projecting into the passageway 26 from a support panel 68 (FIGS. 1 and 2) for receiving or engaging the support bar 50b and permitting relative movement only in a first direction. While in the preferred embodiment the latch 64 is shown on the outer frame 12, it is contemplated that it could alternatively be located on the inner frame 40 for engaging the support panel 68. The ultimate goal is that movement of the inner frame 40 relative to the outer frame 12 is prevented past a certain point so that the inner frame remains within the passageway 26.

Upon the insertion of the inner frame 40 past the latch 64, the assembly of the retriever 10 is complete, and as described above, it is accomplished without the use of tools, in that basically the inner frame 40 is inserted into the passageway 26 until engagement of the latch 64 on the inner frame.

Upon assembly of the inner frame 40 into the outer frame 12, outer edges 72 of the frame members 46 are slidably engaged with at least one of the inner edges 28 of the main rails 14, and inner surfaces of the support panels 20. By squeezing the grip bar 48 against the handle 18, the biasing force of the spring 70 is overcome and the jaws 54 are retracted into the passageway 26.

Referring now to FIGS. 2-5, each of the jaws 54 is provided with a grappling formation, which in the preferred embodiment is an inclined, barbed and preferably half-arrow-shaped tab 74 at its free end 58. Each tab 74 is also provided with a shoulder 76. As will be described below, the tabs 74 are designed to releasably engage a disposable waste container 80, and upon movement of the inner frame 40 relative to the outer frame 12, cause the container to move from an open position to a closed position.

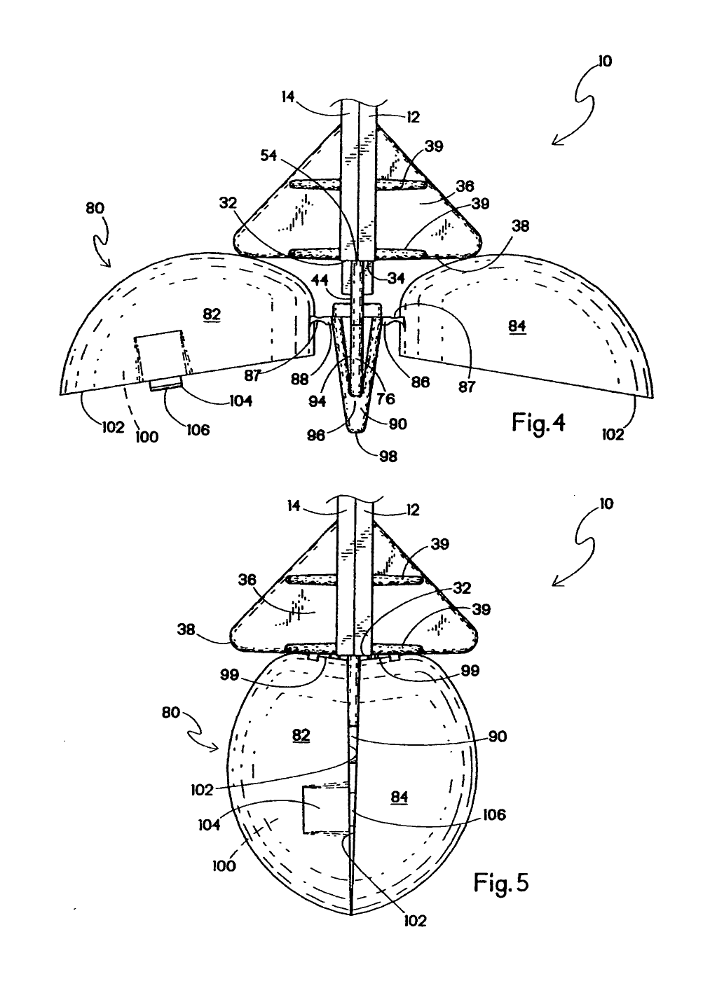

Forming the third main component of the assembled retriever 10, the disposable waste container 80 is preferably made of inexpensive plastic or the like, and is of the clamshell type, with two opposing halves 82, 84 hingedly joined along a common side edge 86 to be movable between an open position (FIG. 4) and a closed position (FIG. 5). In the preferred embodiment, the common edge 86 is wide enough to form a spine which separates the clamshell halves 82, 84 and two web-like “living hinges” 87 are provided. Thus, the present use of “common edge” contemplates that it is not required that the halves 82, 84 be in actual physical contact with each other, and the number of hinges 87 and the width of the spine may vary to suit the application.

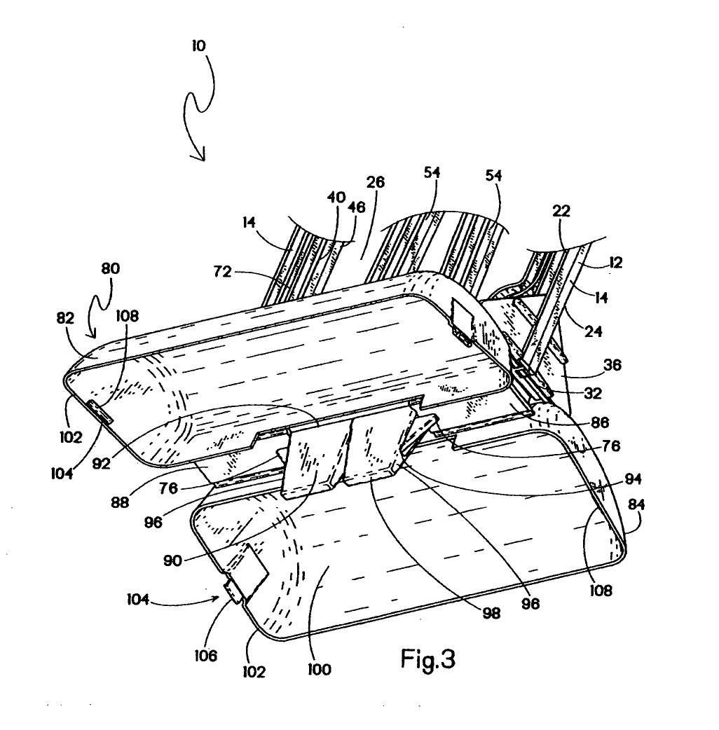

In a central panel 88 (FIGS. 3 and 4) of the spine is formed at least one and preferably two pockets 90, each constructed and arranged to accommodate a corresponding one of the grappling formations or tabs 74. As such, the pockets can be termed grappling points, since they engage the grappling formations 74. The pockets 90, preferably disposed adjacent each other in the container 80, have open upper ends 92 communicating with ambient and are otherwise closed except for slits 94 located in outside side edges 96. The slits 94 are dimensioned for accommodating the barb-like shoulders 76 of the tabs 74. As will be seen in FIG. 3, the pockets 90 are generally tapered toward the inside of the clamshell container 80 and have wider edges adjacent the open upper end 92 than at closed tips 98. It is contemplated that the pockets 90 are provided without the slits 94, but the grappling formations can be modified for accommodating the barb-like shoulders 76 of the tabs 74, for example by expanding the pockets laterally.

Also, while the tab and pocket configuration is depicted here, it is contemplated that any type of grappling engagement be provided whereby the jaws 54 are releasably engageable with the container 80 adjacent the common edge so that retraction of the inner frame 40 relative to the outer frame 12 causes movement of the container from an open position to a closed position. Furthermore, while the preferred embodiment depicts the container 80 as being engaged and disengaged axially relative to the frames 12, 40, it is also contemplated that the container could be engaged through a lateral or transverse movement. Also, referring to FIG. 5, it will be seen that rear surfaces 99 of the container halves 82, 84 are slightly inclined toward the pockets 90 to facilitate the closing power of the cam lobes 38.

The clamshell container 80 is designed so that, upon closure, the pet waste is contained for disposal. An inner space 100 defined by the halves 82, 84 is dimensioned to accommodate most pet waste droppings at a single occurrence, although it is contemplated that the size of the container 80, or of the retriever 10 may vary to suit the size of the pet.

Another feature of the clamshell container 80 is that it is provided with a latch system 104 so that opposing portions 102 of the clamshell halves 82, 84 are attachable to each other for holding the clamshell halves together after the container encloses pet waste. While other latch systems are contemplated, including adhesives or other types of latches, the preferred fastening system 104 (FIGS. 3-5) is an integral hook 106 on one edge 102, and an aperture or recess 108 on an opposite edge 102, the hook and recess being dimensioned to securely close upon retraction of the inner frame 40 relative to the outer frame 12 as will be described presently. It will be seen that on the container halves 82, 84, each half has a hook 106 and a recess 108 at opposing ends, however other arrangements are contemplated depending on the application. Also, it is preferred that even in the closed position (FIG. 5), there is sufficient gap between the opposing halves 82, 84 to allow the escape of grass or other vegetation which might impede the removal of the waste 110.

Referring now to FIGS. 3-7, in use, the user attaches the container 80 to the inner frame 40 by a rapid jab of the retriever 10 into a vertical stack of the containers. The tabs 74, which in a rest position (FIG. 1) of the retriever 10 project below the container end 32, are drawn together with progressive insertion into the pockets 90 by the tapered shape of the pockets. Once the shoulders 76 engage and project through the side slits 94, the jaws 54 are biased laterally, the inner frame 40 is locked onto the container, the user lifts the retriever 10 away from the stack of containers 80, and is ready to take the pet for a walk.

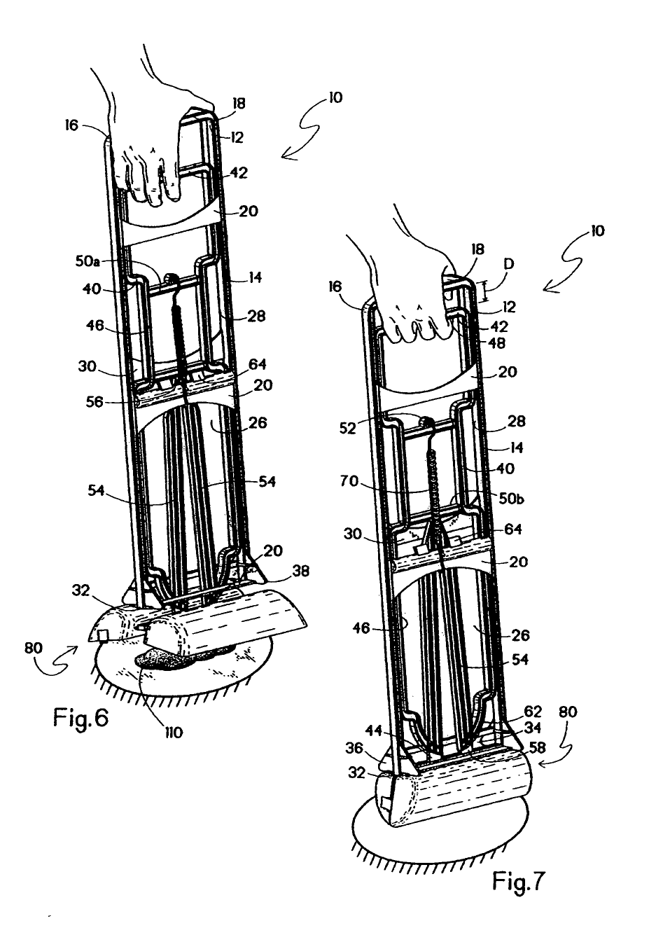

As seen in FIG. 6, once it is time to retrieve pet waste 110, the user grasps the retriever 10 at the handle end 16 and positions the container 80 over the waste 110. The grip end 42 of the inner frame 40 is grasped and pulled toward the handle end 16. In so doing, the tabs 74 are retracted into the opening 34 at the container end 32 and referring to FIGS. 4 and 5, generally arcuate or curved outer surfaces 112 of the clamshell halves 82, 84 are caused to rotate to a closed position through engagement with the cam lobes 38.

Referring now to FIG. 7, as the user pulls the inner frame 40 against the handle 18, the pulling force, while counter to the biasing force of the spring 70, is sufficient to cause the fastener system 104 to engage and secure the waste 110 within the container 80. Note that, even in the container closed position, there is a distance or separation “D” between the handle 18 and the grip end 42.

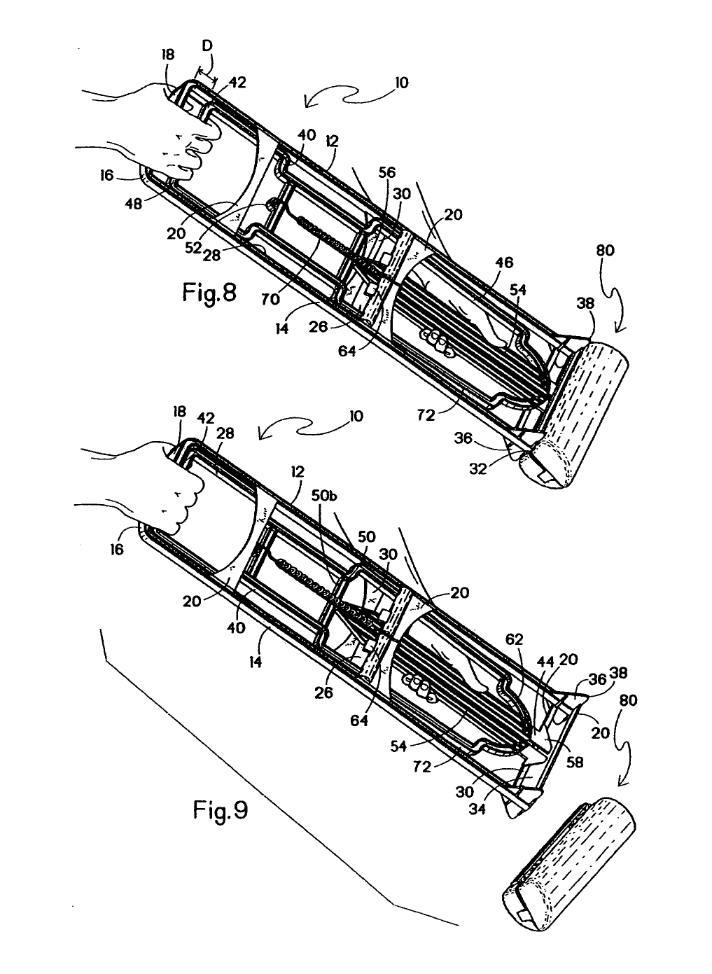

Referring now to FIGS. 8 and 9, once the user wants to dispose of the contained waste, the retriever 10 is positioned over a waste receptacle (not shown) so that the container 80 will fall into it. The jaws 54 are grasped together, which overcomes the inherent lateral biasing force, and retracts the shoulders 76 from the slits 94 in the pockets 90 (FIG. 3). Next, the inner frame 40 is retracted further relative to the outer frame 12, not exceeding the length of the separation D. This relative movement can be accomplished using two hands, as seen in FIG. 9, or can be accomplished with the handle pressed against the user's body or other support surface. Ejection of the container 80 from the retriever 10 is facilitated when the retractive movement of the inner frame 40 is performed in an abrupt manner. It has been found that the inclined shape of the pockets 90 facilitates the ejection of the container 80. In some cases, the ejection of the container 80 can be accomplished by only squeezing the jaws 54 together.

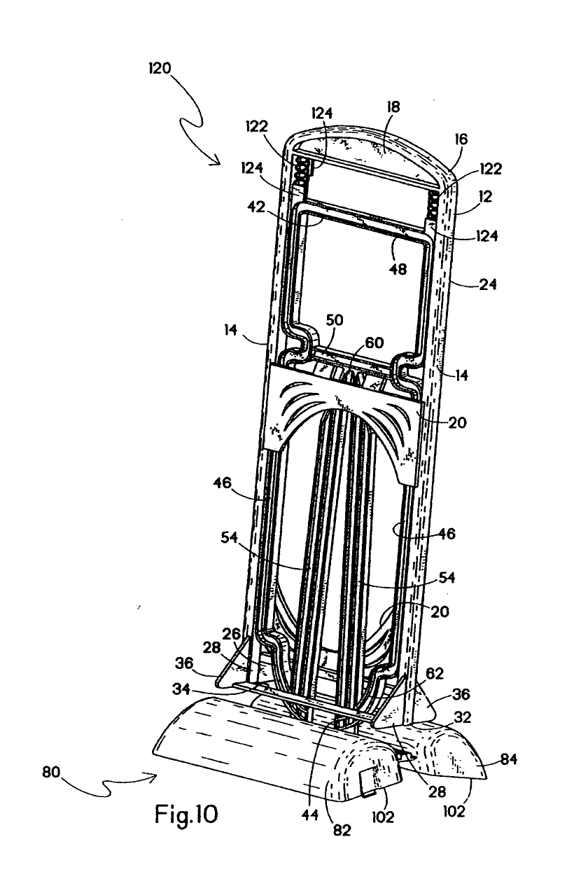

Referring now to FIG. 10, an alternate embodiment of the waste retriever 10 is generally designated 120. Shared components of the two embodiments are designated with identical reference numbers. A main distinction of the retriever 120 is its overall profile, which is relatively shorter in length than the retriever 10. Another feature of the retriever 120 is the location of the biasing members, here designated 122. Two are provided, in the form of coiled springs which bias the inner frame 40 away from the outer frame 12. The biasing members 122 are preferably retained in position through the use of barrier walls 124 located on at least one of and preferably both the inner and outer frames 40, 12. It will be seen that the barrier alls 124 are constructed and arranged to retain the springs 122 while accommodating the relative sliding movement of the inner frame 40. However, it is also contemplated that the biasing members could be retained by the use of integral locating lugs, adhesives or the like. Further there is preferably only one support bar 50. Operation of the retriever 120 is the same as the retriever 10.

Thus, it will be seen that the present pet waste retriever 10 provides for sanitary collection and disposal of pet waste in a manner which greatly reduces the possibility of a user contacting the container holding the waste. Further, after use, the retriever 10 is not contaminated with pet waste, and can be carried and/or stored as the user desires. One-handed operation is possible to allow the user to maintain control of the pet while waste is disposed of. Also, the present retriever 10 is simple to assemble and operate.

While a particular embodiment of the present pet waste retriever with removable container has been described herein, it will be appreciated by those skilled in the art that changes and modifications may be made thereto without departing from the invention in its broader aspects and as set forth in the following claims.

1. A pet waste retriever for use with a disposable container, comprising:
an outer frame defining a central passageway and having a handle end, and an opposite container end defining an opening in communication with said passageway;
an inner frame dimensioned for sliding engagement in said passageway and having a grip end associated with said handle end and a jaw end associated with said container end, said jaw end provided with at least one jaw; and
said inner frame being assembled into said outer frame without the use of tools.

2. The waste retriever of claim 1 further including a latch on at least one of said inner frame and said outer frame for slidably retaining said inner frame in said passageway.

3. The waste retriever of claim 2 wherein said latch includes at least one ramped barb projecting into said passageway for receiving a support member of said inner frame and permitting relative movement only in a first direction.

4. The waste retriever of claim 1 wherein said outer frame includes at least one mounting point and a biasing member engageable on said mounting point and on said inner frame for biasing said inner frame relative to said outer frame.

5. The waste retriever of claim 4 being constructed and arranged so that upon connection of said biasing member to said inner and outer frames, said inner member is biased to an open position wherein said jaws project through said opening, and said grip end is movable towards said handle end against a force exerted by said biasing member.

6. The waste retriever of claim 1 wherein said at least one jaw includes a pair of jaws being biased laterally relative to each other.

7. The waste retriever of claim 6 wherein each said jaw includes a grappling formation for engaging an associated grappling point on the disposable container.

8. The waste retriever of claim 7 wherein said grappling formation is a barbed end for engaging a receptacle in the disposable container.

9. The waste retriever of claim 7 wherein said jaws are configured to be squeezable together by a user for overcoming said lateral biasing force, and said inner frame being slidable relative to said outer frame towards said handle end for ejection of the disposable container.

10. The waste retriever of claim 1 further including at least one cam associated with said container end for engaging a corresponding clamshell half of the disposable container as said inner frame is pulled toward said handle end of said outer frame, said action closing the container.

11. A pet waste retriever for use with a disposable container, comprising:
an elongate outer frame defining a central passageway and having a handle end, and an opposite container end defining an opening in communication with said passageway;
an elongate inner frame dimensioned for sliding engagement in said passageway and having a grip end associated with said handle end and a jaw end associated with said container end; and
said jaw end provided with a pair of laterally biased jaws, each said jaw includes a barbed end for engaging a receptacle in the disposable container.

12. The waste retriever of claim 11 wherein said jaws project through said opening in a rest position.

13. The waste retriever of claim 11 wherein said jaws are laterally biased away from each other and are configured to be squeezable together by a user for overcoming said lateral biasing force, and for ejection of the disposable container.

14. the waste retriever of claim 11 wherein each said jaw includes a barbed end for engaging a receptacle in the disposable container.

15. The waste retriever of claim 11 further including at least one cam associated with said container end and configured for engaging a corresponding clamshell half of a disposable container as said inner frame is pulled toward said handle end of said outer frame, said action closing the container.

16. A disposable clamshell container configured for use with a pet waste retriever having an outer frame defining a central passageway and having a handle end, and an opposite container end defining an opening in communication with the passageway, an elongate inner frame dimensioned for sliding engagement in the passageway and having a grip end associated with the handle end and a jaw end associated with the container end, the container end provided with a pair of barbed jaws , said container comprising:
first and second clamshell halves hingedly joined along a common edge, said clamshell halves defining a storage space for pet waste;
opposing portions of said clamshell halves being attachable to each other for holding the clamshell halves together; and
at least one grappling point associated with said common edge and constructed and arranged so that a pulling force acting on said grappling point will cause said clamshell halves to close.

17. The disposable clamshell container of claim 16 wherein said at least one grappling point further includes at least one pocket formed in said common edge having an opening said at least one pocket projecting generally normally into said storage space and constructed and arranged for receiving a corresponding one of the barbed jaws.

18. The container of claim 16 wherein each said pocket has an open edge disposed and arranged for receiving the barb of the corresponding jaw.

19. The container of claim 18 further including a pair of said pockets disposed adjacent each other.

20. The container of claim 16 further including a latch mechanism for attaching together said opposing clamshell halves.
